(19) United States
(12) Patent Application Publication
(10) Pub. No.: US 2026/0012552 A1
(43) Pub. Date: Jan. 8, 2026

(54) EFFECT PROCESSING METHOD, ELECTRONIC DEVICE, AND STORAGE MEDIUM

(71) Applicant: Beijing Zitiao Network Technology Co., Ltd., Beijing (CN)

(72) Inventors: Can WANG, Beijing (CN); Yi CHEN, Beijing (CN); Fukun XU, Beijing (CN)

(21) Appl. No.: 19/259,926

(22) Filed: Jul. 3, 2025

(30) Foreign Application Priority Data
Jul. 5, 2024 (CN) 202410903365.9

(51) Int. Cl. H04N 5/262

(52) U.S. Cl. CPC H04N 5/262

(57) ABSTRACT

An effect processing method, an electronic device, and a storage medium are provided. The effect processing method includes: in response to an effect trigger operation acting on a target display region, determining a first effect to be added and acquiring an image to be processed in the target display region; in response to a second effect not being added to the image to be processed, displaying the first effect in a first interaction mode; and in response to the second effect being added to the image to be processed, displaying the first effect in a second interaction mode that is different from the first interaction mode.

### CROSS-REFERENCE TO RELATED APPLICATION

This application claims the priority to and benefits of the Chinese Patent Application, No. 202410903365.9, which was filed on July 5, 2024, and is hereby incorporated by reference in its entirety.

### TECHNICAL FIELD

Embodiments of the present disclosure relate to the computer application technology, and in particular to an effect processing method, an electronic device, and a storage medium.

### BACKGROUND

In a scenario of image processing or video production, the application of effects is favored by users. The user can use a selected effect to process an image or a video, so that the obtained effect image presents an effect performance corresponding to the effect.

In the related art, when a plurality of effects are added to a same target object, the effect added later may fail to present an expected performance, and even affect a display performance of the added effect, resulting in a poor overall performance of a picture and affecting the usage experience of the effects.

### SUMMARY

The present disclosure provides an effect processing method and apparatus, an electronic device, a storage medium, and a program product to achieve the performance that when a first effect to be added and a second effect that has been added are jointly added to an image to be processed, the effect acting performance of the first effect to be added is not affected by the other effect acting performance.

At least an embodiment of the present disclosure provides an effect processing method, which includes:

in response to an effect trigger operation acting on a target display region, determining a first effect to be added and acquiring an image to be processed in the target display region;

in response to a second effect not being added to the image to be processed, displaying the first effect in a first interaction mode, where the first effect and the second effect have a same preset interaction object; and

in response to the second effect being added to the image to be processed, displaying the first effect in a second interaction mode that is different from the first interaction mode. At least an embodiment of the present disclosure provides an effect processing apparatus, which includes:

an effect trigger module configured to, in response to an effect trigger operation acting on a target display region, determine a first effect to be added and acquire an image to be processed in the target display region;

a first interaction module configured to, in response to a second effect not being added to the image to be processed, display the first effect in a first interaction mode, where the first effect and the second effect have a same preset interaction object; and

a second interaction module configured to, in response to the second effect being added to the image to be processed, display the first effect in a second interaction mode that is different from the first interaction mode.

At least an embodiment of the present disclosure provides an electronic device, which includes:

at least one processor; and

at least one memory, configured to store at least one program,

where, the at least one program, upon being executed by the at least one processor, causes the at least one processor to implement the effect processing method according to any of the embodiments of the present disclosure.

At least an embodiment of the present disclosure provides a non-transitory computer- readable storage medium including computer-executable instructions, where the computer- executable instructions, upon being executed by a processor, executes the effect processing method according to any of the embodiments of the present disclosure.

At least an embodiment of the present disclosure provides a computer program product, which includes computer programs, where the computer programs upon being executed by a processor, implement the effect processing method according to any of the embodiments of the present disclosure.

### BRIEF DESCRIPTION OF DRAWINGS

The above and other features, advantages, and aspects of embodiments of the present disclosure will become more apparent from the following detailed description when taken in conjunction with the accompanying drawings. Throughout the drawings, the same or similar reference numbers refer to the same or similar elements. It should be understood that the drawings are schematic and that components and elements are not necessarily drawn to scale.

FIG. 1 is a flow diagram of an effect processing method provided by an embodiment of the present disclosure;

FIG. 2 is a flow diagram of another effect processing method provided by an embodiment of the present disclosure;

FIG. 3 is a schematic diagram of an effect processing flow under a condition of a plurality of layers provided by an embodiment of the present disclosure;

FIG. 4 is a structural schematic diagram of an effect processing apparatus provided by an embodiment of the present disclosure; and

FIG. 5 is a structural schematic diagram of an electronic device provided by an embodiment of the present disclosure.

### DETAILED DESCRIPTION

Embodiments of the present disclosure are described in more detail below with reference to the drawings. Although certain embodiments of the present disclosure are shown in the drawings, it should be understood that the present disclosure may be achieved in various forms and should not be construed as being limited to the embodiments described here. On the contrary, these embodiments are provided to understand the present disclosure more clearly and completely. It should be understood that the drawings and the embodiments of the present disclosure are only for exemplary purposes and are not intended to limit the scope of protection of the present disclosure.

It should be understood that various steps recorded in the implementation modes of the method of the present disclosure may be performed according to different orders and/or performed in parallel. In addition, the implementation modes of the method may include additional steps and/or steps omitted or unshown. The scope of the present disclosure is not limited in this aspect.

The term "including" and variations thereof used in this article are open-ended inclusion, namely "including but not limited to". The term "based on" refers to "at least partially based on". The term "one embodiment" means "at least one embodiment"; the term "another embodiment" means "at least one other embodiment"; and the term "some embodiments" means "at least some embodiments". Relevant definitions of other terms may be given in the description hereinafter.

It should be noted that concepts such as "first" and "second" mentioned in the present disclosure are only used to distinguish different apparatuses, modules or units, and are not intended to limit orders or interdependence relationships of functions performed by these apparatuses, modules or units.

It should be noted that concepts such as "one" and "more" mentioned in the present disclosure are schematic rather than restrictive, and those skilled in the art should understand that unless otherwise explicitly stated in the context, it should be understood as "one or more".

The names of messages or information interacted between a plurality of apparatuses in the embodiments of the present disclosure are used for illustrative purposes only and are not intended to limit the scope of those messages or information.

It can be understood that before using the technical solutions disclosed in various embodiments of the present disclosure, users should be informed of the types, scope of use, use scenarios, etc. of personal information involved in the present disclosure in an appropriate way according to relevant laws and regulations and be authorized by the users.

For example, in response to receiving an active request from a user, prompt information is sent to the user to clearly prompt the user that an operation requested by the user to be performed will require acquisition and use of personal information of the user. Therefore, the user can independently choose whether to provide personal information to software or hardware such as a computer device, an application program, a server or a storage medium that performs the operations of the technical solution of the present disclosure according to the prompt information.

As an optional but non-limiting implementation, in response to receiving the active request of the user, the prompt information may be sent to the user by, for example, a pop-up window, in which the prompt information can be presented in the form of text. In addition, the pop-up window can also carry a selection control for the user to choose "agree" or "disagree" to provide personal information to the computer device.

It can be understood that the above process of notifying and acquiring user authorization is only schematic, and does not limit the implementation of the present disclosure, and other ways meeting relevant laws and regulations may also be applied to the implementation of the present disclosure.

It can be understood that data referred to in this technical solution (including but not limited to the data itself, the acquisition or use of the data) should comply with the requirements of the applicable laws and regulations and related regulations.

Before the technical solution is introduced, an application scenario may be exemplarily described. The technical solution may be used in any effect processing scenarios. In order to explain an application scenario of this technical solution more clearly, a live streaming scenario may be used as an example to explain the application scenario. Exemplarily, in the live streaming scenario, a live streaming audio-video stream may be displayed based on a target display region in a display interface. Before a live streaming side starts to live stream or in a live streaming process, an effect trigger operation may be inputted for the target display region to determine an effect added to a video frame, for example, the effect may be a headwear effect acting on a face of a live streamer. In addition, in the live streaming process, an audience side may input the effect trigger operation for the target display region to determine an effect to be added to the video frame, for example, the effect may be a gift effect acting on the face of the live streamer. However, when the headwear effect has been added to the live streamer shown in the video frame in a live data stream, if a gift effect which will also act on the face of the live streamer is added to the face of the live streamer according to its corresponding preset interaction logic, there may be a duplication of the effect acting location, which leads to a poor effect acting performance.

At this time, based on the technical solution of the embodiment of the present disclosure, when the first effect to be added is determined, it may be determined in advance whether a second effect having a same preset interaction object as the first effect is added to the image to be processed on which the first effect acts. Furthermore, the first effect is displayed in a first interaction mode when the second effect is not added to the image to be processed. The first effect is displayed in a second interaction mode different from the first interaction mode when the second effect is added to the image to be processed. Therefore, a performance that the effect interaction mode of the first effect is determined according to whether the corresponding second effect is added to the image to be processed when the first effect is triggered is realized, further, a performance that the effect acting performance of the first effect to be added is not affected by the effect acting performance of other effects when the first effect to be added and the added second effect are added to the image to be processed together is realized, and an overall effect display performance of the effect performance image is improved.

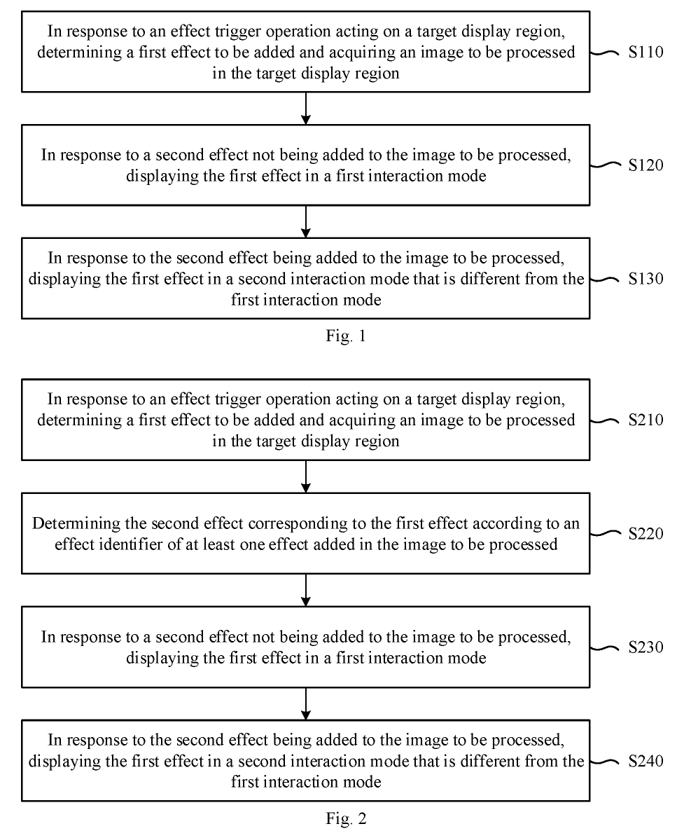

FIG. 1 is a flow diagram of an effect processing method provided by an embodiment of the present disclosure. The embodiment of the present disclosure is suitable for a situation of performing effect processing on images according to a selected effect. The method may be implemented by an effect processing apparatus, which apparatus may be implemented in the form of software and/or hardware, or optionally by an electronic device, which may be a mobile terminal, a PC or a server.

As shown in FIG. 1, the method of the present embodiment may specifically include:

S110: in response to an effect trigger operation acting on a target display region, determining a first effect to be added and acquiring an image to be processed in the target display region.

The target display region may be understood as a display region for displaying multimedia information. Alternatively, the target display region may also be understood as an entry to support the interaction between the user and the displayed multimedia information. Optionally, the multimedia information displayed in the target display region may be at least one of an image, a video, a text and an audio. It should be noted that in different service scenarios, the target display region may display different multimedia information. Exemplarily, in the live streaming scenario, the target display region may be used for displaying a live streaming audio-video stream. The display region corresponding to the audience side of the live streaming audio-video stream may be taken as the target display region, or both the display regions corresponding to the audience side and the live streaming side of the live streaming audio-video stream may be taken as the target display region, which is not limited by the embodiment of the present disclosure. It should also be noted that the target display region may be a region including one display layer or a region including a plurality of display layers. When the target display region includes one display layer, all the received multimedia information may be displayed in the display layer; and when the target display region includes the plurality of display layers, the received multimedia information may be displayed in layers according to a preset display logic.

The effect trigger operation may be understood as an operation of executing an image effect processing flow after being triggered. In general, a control that can trigger effects may be preset in application software or an application program that supports an effect processing function. Furthermore, when it is detected that the user triggers the control, the trigger operation may be responded. Thus, the first effect to be added is determined. The first effect may be understood as an effect that is selected based on the effect trigger operation and is to be added to the multimedia information displayed in the target display region. The first effect may be any type of effect. Optionally, the first effect may be an effect acting on an effect acting object (including a user, a face of the user or other acting objects, etc.), an effect acting on the effect acting object and moving along with the effect acting object, or an effect displayed at a preset display location, etc. The image to be processed may be an image to be subjected to effect processing. In the embodiment of the present disclosure, in a process of displaying an image based on the target display region, the effect trigger operation may be inputted for the target display region. Furthermore, when the effect trigger operation for the target display region is detected, the image currently displayed in the target display region may be taken as the image to be processed. Optionally, the image to be processed may be an image collected by a terminal device or an image acquired from a target storage space (for example, an image library of the application software or a terminal photo album, etc.); alternatively, it may also be an image uploaded by an external device. In order to introduce the first effect and the image to be processed more clearly, the live streaming scenario may be taken as an example to illustrate the first effect and the image to be processed. Exemplarily, in the live streaming scenario, the image to be processed includes a video frame in the live streaming audio-video stream; and the first effect is an effect added by the audience side of the live streaming audio-video stream. In the process of displaying the live streaming audio- video stream in the target display region, the effect trigger operation may be inputted for the target display region. Furthermore, when the effect trigger operation by the audience side for the target display region is detected, the first effect to be added to the live streaming audio-video stream by the audience side is determined in response to the effect trigger operation, and the video frame in the live streaming video stream currently displayed in the target display region may be taken as the image to be processed.

It should be noted that the target display region may include one layer or a plurality of layers. When the target display region includes one layer, the image displayed in the target display region may be taken as the image to be processed. When the target display region includes a plurality of layers, the image to be processed is acquired when the first effect is determined, and the first effect is an effect to be added to the image to be processed. Therefore, when acquiring an image to be processed in the target display region, the layer corresponding to the first effect (that is, the layer where the image to be processed is located) may be determined according to the effect trigger operation, and then the image displayed in this layer may be taken as the image to be processed.

Optionally, acquiring an image to be processed in the target display region includes: in response to the target display region including the plurality of layers, determining a target layer on which the first effect acts from a plurality of layers and acquiring an image to be processed according to the target layer.

The layer may be used for displaying a corresponding image content separately. It may be understood that the image content displayed in the target display region may be separated onto different layers, so that each layer displays the corresponding image content separately. Each of the layers is independent, and all the image contents displayed in the target display region may be obtained by stacking these layers together according to a preset order.

It should be noted that when the target display region includes a plurality of layers, images displayed by different layers may be the same or different. Exemplarily, in the live streaming scenario, the plurality of layers included in the target display region may at least include a layer for displaying a video frame in the live streaming video stream and a layer for previewing an effect performance. In the live streaming process, the layer for displaying the video frame in the live streaming video stream may be used for displaying the image in the live streaming video stream. The image displayed in the layer for previewing the effect performance may be a preset template image. Furthermore, the template image may be subjected to effect processing based on the effect determined by the effect trigger operation, and a performance previewing image corresponding to the effect may be displayed based on this layer. In this case, the images displayed by different layers in the target display region are different. Alternatively, in order to make the effect previewing performance closer to an effect display performance when the effect acts on the video frame in the live streaming video stream, the image displayed in the layer for previewing the effect performance may also be an image in the live streaming video stream, which may be an image collected in the displayed live streaming video stream after the effect trigger operation is received. Furthermore, the image may be subjected to effect processing based on the effect determined by the effect trigger operation, and the effect performance of the effect acting on the image may be displayed based on the layer. In this case, the images displayed by different layers in the target display region are the same.

In other words, the plurality of layers included in the target display region are display layers for displaying different multimedia information independently. Furthermore, the plurality of layers may include a layer on which the first effect acts, and may also include a layer on which the first effect cannot act. The target layer is a layer on which the first effect acts among the plurality of layers included in the target display region. It should be noted that the target layer may be one layer or the plurality of layers, which is not specifically limited by the embodiment of the present disclosure.

As an alternative to the embodiment of the present disclosure, when the target display region includes the plurality of layers, the target layer on which the first effect acts may be selected based on effect processing requirements of the user. In other words, when the user inputs the effect trigger operation for the target display region to determine the first effect, the target layer on which the first effect acts may also be determined based on the effect trigger operation. Further, the image displayed in the target layer may be taken as the image to be processed. Exemplarily, the plurality of layers included in the target display region may include a layer for previewing an effect performance and a layer for displaying a target effect performance. When it is detected that the effect trigger operation inputted by the user for the target display region is an effect previewing operation, the layer for previewing the effect performance may be taken as a target layer on which the first effect acts. When it is detected that the effect trigger operation inputted by the user for the target display region is an effect acting operation, the layer for displaying the target effect performance may be taken as the target layer on which the first effect acts.

As another alternative to the embodiment of the present disclosure, the first effect may be an interaction effect that implements interaction between a service sender and a service receiver in the target service scenario. For example, in the live streaming scenario, the first effect may be a gift effect sent by the audience side to a live streamer side. When the target display region includes the plurality of layers, the plurality of layers may include a layer for displaying the interaction performance between the two sides and a layer without the need to display the interaction performance between the two sides. The layer for displaying the interaction performance between the two sides may be taken as a layer that allows the first effect to act on, and the layer without the need to display the interaction performance between the two sides may be taken as a layer that does not allow the first effect to act on. In a concrete implementation, the layer that allows the first effect to act on and the layer that does not allow the first effect to act on may be set in advance. Furthermore, when the first effect to be added is determined based on the effect trigger operation, the layer that allows the first effect to act on may be determined from the plurality of layers, and may be taken as the target layer. Further, the image displayed in the target layer may be taken as the image to be processed. The advantage of this setting is that when the target display region includes the plurality of layers, the performance of acquiring the image to be processed based on the target layer on which the first effect acts is realized, and further, the acquiring accuracy of the image to be processed is improved when the target display region includes the plurality of layers, thus providing an accurate data basis for subsequent processing of the image to be processed based on the first effect.

Exemplarily, in the live streaming scenario, the first effect may be added to the image to be processed based on the effect trigger operation inputted by the audience side, and the effect trigger operation may be inputted for the target display region based on the live streaming side. Thus, the effect is added to the image to be processed. For the live streaming side, in order to preview the effect acting performance before the effect is added to the image to be processed, an effect previewing layer may be set, and an image content displayed in the effect previewing layer may be an performance previewing image of the effect added by the live streaming side on the image to be processed, where the effect previewing layer may be a layer that does not allow the first effect to act on. In addition to the effect previewing layer, the target display region may also include a layer for displaying a video frame in the live streaming audio-video stream, and this layer may be a layer that allows the first effect to act on. Furthermore, when the first effect to be added is determined, the layer for displaying the video frame in the live streaming audio-video stream in the target display region may be taken as the target layer, and the video frame of the live streaming audio-video stream displayed in the target layer may be taken as the image to be processed.

S120: in response to a second effect not being added to the image to be processed, displaying the first effect in a first interaction mode

The second effect may be understood as an effect that is selected based on the effect trigger operation and acts on the image to be processed displayed in the target display region. The first effect and the second effect have the same preset interaction object. The preset interaction object may be a preset effect acting object. The preset interaction object may be any object, optionally, the user, the face of the user, an animal or other interaction objects. The second effect may be any type of effect. Optionally, the second effect may be an effect acting on the preset interaction object (including the user, the face of the user or other acting objects, etc.), an effect acting on the preset interaction object and moving along with the preset interaction object, or an effect displayed at the preset display location, etc. Exemplarily, in the live streaming scenario, the second effect may be an effect added by the live streaming side of the live streaming audio-video stream, that is, an effect added based on the effect trigger operation inputted by the live streamer. For example, the second effect may be a headwear effect added by the live streaming side and acting on the face of the live streamer.

The first interaction mode may be understood as a mode in which the first effect interacts with its corresponding preset interaction object on the display interface. The first interaction mode may include a mode of displaying the first effect in association with the preset interaction object according to the preset interaction logic. That is to say, the effect interaction mode included in the first interaction mode may be a preset effect acting and display mode corresponding to the first effect. The preset interaction logic may be a pre-edited program code, which may be used for determining the mode of displaying the first effect in association with the preset interaction object. In the embodiment of the present disclosure, the first interaction mode may include that the first effect acts on the target acting location corresponding to the preset interaction object and moves along with the movement of the preset interaction object, and so on. The target acting location may include a preset effect acting location on the preset interaction object and/or an acting location at a preset distance from the preset interaction object. Exemplarily, assuming that the first effect is a headwear effect, the first interaction mode may be that the headwear effect acts on a head of the preset interaction object and moves along with the movement of the preset interaction object; alternatively, the first interaction mode may be that the headwear effect acts at a location 5 mm away from the preset interaction object and moves along with the movement of the preset interaction object.

In the embodiment of the present disclosure, when the image to be processed is acquired, the image to be processed may be processed to determine the effect added in the image to be processed. Furthermore, it may be determined whether there is the second effect among the added effects according to the first effect. Further, when it is determined that the second effect is not added to the image to be processed, the first effect may be displayed in the first interaction mode.

As an alternative to the embodiment of the present disclosure, when the image to be processed is acquired, the target layer corresponding to the image to be processed may be processed to determine the added effect in the image to be processed. Further, according to the preset interaction object corresponding to the first effect, it may be determined whether there is an effect whose corresponding preset interactive object is the same as the preset interaction object corresponding to the first effect among the added effects. After that, it may be determined that the second effect is not added to the image to be processed when it is determined that there is no effect whose corresponding preset interactive object is the same as the preset interaction object corresponding to the first effect among the added effects. Furthermore, the first interaction mode corresponding to the first effect may be acquired, and the first effect is displayed in association with the corresponding preset interaction object in the image to be processed according to the first interaction mode.

It should be noted that the first interaction mode and the first effect may be in one-to- one correspondence. That is, the first interaction mode may vary according to the first effect to be added.

S130: in response to the second effect being added to the image to be processed, displaying the first effect in a second interaction mode that is different from the first interaction mode.

The second interaction mode may be understood as a mode of displaying the first effect

in the image to be processed when the image to be processed includes the second effect. In the embodiment of the present disclosure, the second interaction mode may be an additional mode of displaying the first effect in the image to be processed in order not to affect the effect display performance of the second effect. It should be noted that the second interaction mode is an effect display mode different from the first interaction mode. The first interaction mode is an effect display mode of displaying the first effect in association with the preset interaction object; and the effect display mode included in the second interaction mode may include that the first effect is not displayed in association with the preset interaction object. That is to say, when the first effect is displayed in the second interaction mode, the first effect may be displayed at any location on the image to be processed and does not move with the movement of the preset interaction object. The second interaction mode may include a plurality of effect display modes. Optionally, the second interaction mode at least includes a mode of displaying the first effect in the preset region of the image to be processed according to the preset display logic. The preset display logic may be understood as a pre-edited program code, which may be used for indicating a mode of displaying the first effect in the preset region of the image to be processed. The preset region may be any region in the image to be processed. Optionally, the preset region may be an upper-left region, an upper-right region, a lower-right region, a lower-left region or a middle region, etc. Exemplarily, when the first effect is displayed according to the second interaction mode, the first effect may be displayed in the upper-left region of the image to be processed. In the embodiment of the present disclosure, the second interaction mode may further include a mode of dynamically displaying the first effect in the image to be processed according to a preset display trajectory. Exemplarily, when the first effect is displayed according to the second interaction mode, the first effect may be dynamically displayed along an edge of the image.

In a practical application, a variety of effects may be added to the image to be processed based on the effect trigger operation. In this process, there may be a case where after an effect has been added to the image to be processed, another effect to be added has a preset interaction object that is identical to that of the effect. At this time, if another effect to be added is added to the preset interaction object according to its corresponding preset interaction logic, there may be a duplication of the effect acting location, leading to a poor effect acting performance. Alternatively, in general, the effect acting location is usually determined according to a location of the preset interaction object in the display interface acquired by a camera apparatus. When the effect has been added to the preset interaction object in the image to be processed, the location of the preset interaction object in the display interface may be changed. At this time, there may be a case where the effect acting location is not accurate, leading to a poor effect acting performance.

In view of the above situation, in the embodiment of the present disclosure, when the image to be processed is acquired, the image to be processed may be processed to determine the effect added in the image to be processed. Furthermore, it may be determined whether there is the second effect among the added effects according to the first effect. Further, when it is determined that the second effect is added to the image to be processed, the first effect may be added to the image to be processed and displayed in the second interaction mode different from the first interaction mode.

In the technical solution of the embodiment of the present disclosure, by determining the first effect to be added and acquiring the image to be processed in the target display region in response to the effect trigger operation acting on the target display region, key information required for effect processing can be automatically, accurately and quickly acquired after the effect is triggered. Further, by displaying the first effect in the first interaction mode when the second effect is not added to the image to be processed, because the first effect and the second effect have the same preset interaction object, in order to ensure the display performance of the first effect, the effect performance of interaction between the first effect and the interaction object can be presented in the first interaction mode; and when the second effect is added to the image to be processed, in order to ensure that the first effect does not affect the display performance of the second effect and can ensure its own display performance, the first effect is displayed in the second interaction mode different from the first interaction mode. Accordingly, the problem that the performance of the effect added later in the related art cannot present an expected performance or even affect an original image performance is solved, an performance that the effect interaction mode of the first effect is determined separately, according to whether the corresponding second effect is added to the image to be processed that is acquired when the first effect is triggered, is realized, and the first effect can be displayed differently in different scenarios, thus enriching a performance presentation mode of the first effect and improving the overall effect display performance of the effect performance image.

FIG. 2 is a flow diagram of another effect processing method provided by an embodiment of the present disclosure. According to the technical solution of this embodiment based on the above embodiment, after the first effect to be added is determined, the second effect corresponding to the first effect can be determined from at least one effect added in the image to be processed according to the first effect. For specific implementations, see the description of this embodiment. The technical features the same as or similar to those of the previous embodiments are omitted here.

As shown in FIG. 2, the method of the present embodiment may specifically include:

S210: in response to an effect trigger operation acting on a target display region, determining a first effect to be added and acquiring an image to be processed in the target display region.

S220: determining the second effect corresponding to the first effect according to an effect identifier of at least one effect added in the image to be processed.

The effect identifier may be used for identifying the corresponding effect. In the embodiment of the present disclosure, the effect identifier may be used for indicating the preset interaction object and/or the preset interaction mode of the effect. The effect identifier may be represented in many forms. Optionally, the effect identifier may be represented by a character string consisting of one or more characters; alternatively, the effect identifier may also be represented by an icon, and so on.

As an alternative to the embodiment of the present disclosure, after the image to be processed is acquired, the effect added in the image to be processed may be determined, and the effect identifier of the added effect may be acquired. Further, the effect identifier of at least one added effect may be parsed to determine the preset interaction object of the corresponding effect. Further, an effect whose corresponding preset interaction object is the same as that of the first effect may be determined from the at least one added effect, and the determined effect may be taken as the second effect.

As another alternative to the embodiment of the present disclosure, an effect identifier of the first effect and effect identifiers of various effects may be acquired in advance, and a mapping relationship between the first effect and at least one effect may be established according to the effect identifiers of the effects. Further, when the first effect is determined, the effect identifier of the first effect may be acquired, and a query may be made in the pre-established mapping relationship according to the effect identifier of the first effect. Further, the second effect corresponding to the first effect may be determined.

In a practical application, a shared memory object is usually set for the effect processing flow, and effect identifiers of all effects to be added to the target display region may be stored based on the shared memory object. Furthermore, when determining the second effect corresponding to the first effect according to the effect identifier, the determination may be made based on the effect identifier stored in the shared memory object. However, when the target display region includes a plurality of layers, these layers include a layer on which the first effect acts and a layer on which the first effect does not act, and each layer may include different effects to be added. In a process of effect processing, the effect identifiers corresponding to the effects included in each layer are written into the shared memory object. When determining the second effect corresponding to the first effect based on the effect identifier stored in the shared memory object, there may be a case where the determined second effect is in the layer on which the first effect does not act. Furthermore, when it is determined that the second effect is added to the image to be processed based on the effect determination result and the first effect is displayed in the second interaction mode, the effect acting performance of the first effect in the corresponding layer may be affected, and the effect display performance of other layers may also be affected.

In view of the above situation, in the embodiment of the present disclosure, the target display region includes a plurality of layers; a layer memory object is disposed in each of the layers; and the layer memory object is at least configured to store the effect identifier of at least one effect added in the layer. The advantage of this setting is that it can accurately render effect acting data in the corresponding layers under a condition of multi-layer overlapping.

The plurality of layers included in the target display region may be used for displaying different screen contents. Exemplarily, in the live streaming scenario, the layers at least include the layer for displaying the video frame in the live streaming video stream and/or the layer for previewing the effect performance. The layer for previewing the effect performance may be displayed above the layer for displaying the video frame in the live streaming video stream. A display size of the layer for previewing the effect performance may be less than that of the layer for displaying the video frame in the live streaming video stream, and the layer for previewing the effect performance may be displayed in the preset display location of the target display region. The preset display location may be any location in the target display region. Optionally, the preset display location may be an upper left of the region, an upper right of the region, a lower right of the region, a lower left of the region or a middle of the region. It should be noted that in the live streaming scenario, both the target display region corresponding to the audience side and the target display region corresponding to the live streaming side may include the layer for displaying the video frame in the live streaming video stream and/or the layer for previewing the effect performance. In this case, when the video frame of the live streaming video stream is displayed on the layer for displaying the video frame of the live streaming video stream, it may be displayed based on the target display region corresponding to the audience side and the target display region corresponding to the live streamer side. When the effect performance is displayed in the layer for previewing the effect performance included in the target display region corresponding to the audience side, the target display region corresponding to the live streaming side does not display this effect performance; and when the effect performance is displayed in the layer for previewing the effect performance included in the target display region corresponding to the live streaming side, the target display region corresponding to the audience side does not display this effect performance.

The layer memory object may be understood as an entity used for storing the effect acting data included in the layer. The layer memory object may be used for storing at least the effect identifier of at least one effect added in the layer. The layer memory object may be any form of entity set in memory, or optionally, an array.

Optionally, determining the second effect corresponding to the first effect according to an effect identifier of at least one effect added in the image to be processed includes: determining a target layer on which the first effect acts from the plurality of layers included in the target display region, and determining the second effect corresponding to the first effect according to the effect identifier stored in the layer memory object corresponding to the target layer.

In the embodiment of the present disclosure, when the target display region includes a plurality of layers, the target layer on which the first effect acts may be determined from the plurality of layers according to the preset layer acting logic. Further, the layer memory object corresponding to the target layer may be determined, and the effect identifier of at least one effect added in the target layer may be determined according to the layer memory object. Furthermore, the second effect corresponding to the first effect may be determined according to the effect identifier of at least one effect added in the target layer.

It should be noted that when the first effect to be added is determined, a flow of rendering the first effect to the image to be processed is to be executed later may be indicated. In general, before an effect rendering operation is executed, it is necessary to write the data to be rendered into the shared memory object to perform the effect rendering operation based on the shared memory object. Therefore, for the target layer on which the first effect acts, before the effect rendering operation corresponding to the target layer is executed, the effect identifier stored in the layer memory object corresponding to the target layer may be written into the shared memory object, and further, the second effect corresponding to the first effect may be determined based on the effect identifier in the shared memory object.

Optionally, determining the second effect corresponding to the first effect according to the effect identifier stored in the layer memory object corresponding to the target layer includes: writing the effect identifier stored in the layer memory object corresponding to the target layer into a shared memory object corresponding to the layer; and determining the second effect corresponding to the first effect according to the effect identifier in the shared memory object.

The shared memory object corresponding to the layer may be understood as a shared entity for temporarily storing effect acting data included in the plurality of layers. That is to say, the effect acting data included in each layer included in the target display region may be temporarily stored in the shared memory object. In the embodiment of the present disclosure, the shared memory object may be used for temporarily storing the effect identifier of at least one effect added in each layer. "Temporarily storing" may be understood as, when the effect rendering operation is executed on the corresponding layer, writing the effect identifier of at least one effect added in the corresponding layer into the shared memory object. After that, when the effect rendering operation is executed on other layers, the written effect identifier may be removed from the shared memory object, and the effect identifier of at least one effect added in other layers may be written.

As an alternative to the embodiment of the present disclosure, when the target layer is determined, the effect identifier stored in the layer memory object corresponding to the target layer may be written into the shared memory object corresponding to the layer. Currently, the shared memory object only includes the effect identifier of at least one effect added in the target layer. Further, the second effect corresponding to the first effect may be determined from the effect identifier included in the shared memory object. The advantages of this setting are as follows: a performance of rendering the effects by layers when the target display region includes the plurality of layers is realized, and a performance of previewing the effects without affecting the interaction between the effects in other layers is realized.

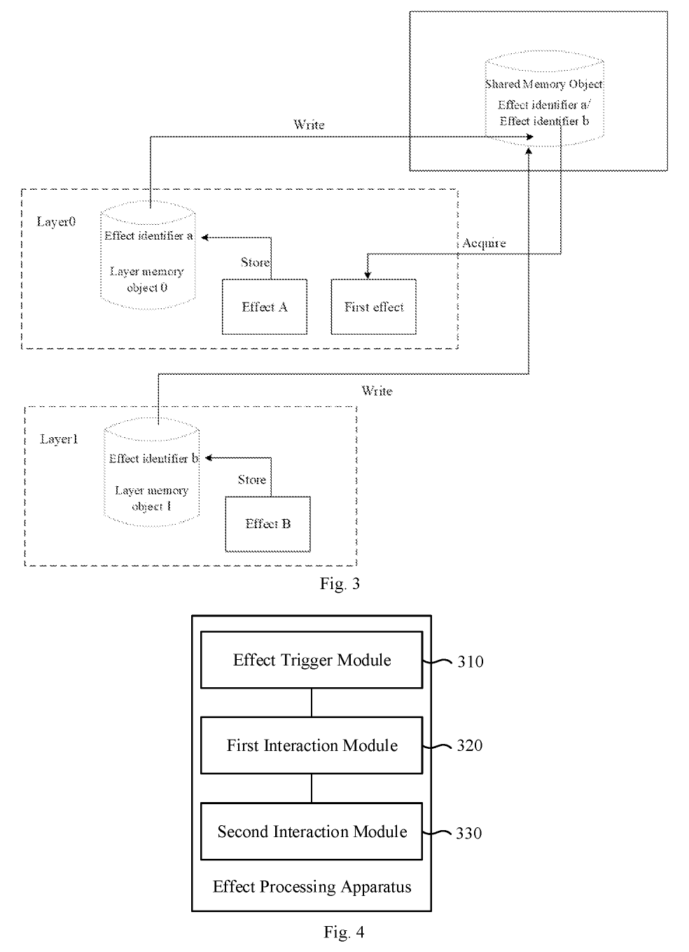

Exemplarily, FIG. 3 is a schematic diagram of an effect processing flow under a condition of a plurality of layers provided by an embodiment of the present disclosure. As shown in FIG. 3, the target display region may include two layers, namely a layer 0 and a layer 1. Moreover, each layer is provided with a layer memory object, which are layer memory object 0 and layer memory object 1, respectively. The layer 0 may be taken as the layer for displaying the video frame in the live streaming audio-video stream, and the layer 1 may be taken as the layer for previewing the effect performance. The target layer on which the first effect acts may be the layer 0. When adding an effect A to the layer 0, an effect identifier a corresponding to the effect A may be stored in the layer memory object 0 . When adding an effect B to the layer 1, an effect identifier b corresponding to the effect B may be stored in the layer memory object 1. Further, when the first effect to be added is determined and the target layer on which the first effect acts is rendered, the effect identifier a stored in the layer memory object 0 may be written into the shared memory object, and the second effect corresponding to the first effect may be determined according to the effect identifier included in the shared memory object. When rendering the layer 1, the effect identifier b stored in the layer memory object 1 may be written into the shared memory object, and then the effect rendering operation is executed.

In the embodiment of the present disclosure, in order to be able to determine the effect identifier of the corresponding effect without affecting other interaction operations in a process of acquiring the effect identifier of at least one effect added to the image to be processed, a protocol corresponding to the effect for carrying the effect identifier may be configured, and further, the effect identifier of the effect may be determined according to the corresponding protocol.

Optionally, before determining the second effect corresponding to the first effect according to an effect identifier of at least one effect added in the image to be processed, the effect processing method further includes: acquiring an effect protocol of at least one effect added in the image to be processed and determining the effect identifier of the effect according to the effect protocol.

The effect protocol may be understood as a pre-configured rule with a fixed format for carrying an effect identifier. The effect protocol may include the effect identifier.

In the embodiment of the present disclosure, when the image to be processed is acquired, the effect protocol of at least one effect added in the image to be processed may be acquired. Further, parsing may be performed according to the obtained effect protocol, and the effect identifier of the effect may be determined according to a protocol parsing result.

Optionally, before acquiring an effect protocol of at least one effect added in the image to be processed, the effect processing method further includes: in response to an identifier configuration operation inputted for at least one effect, configuring a pre-built effect identifier array based on the identifier configuration operation, to obtain the effect protocol corresponding to the effect.

The effect protocol includes the effect identifier of the effect. The identifier configuration operation may be understood as an operation for configuring the effect protocol corresponding to the effect identifier. The effect identifier array may be understood as an array for characterizing specific information of the effect identifier.

In the embodiment of the present disclosure, when at least one effect added to the image to be processed is determined, the identifier configuration operation may be inputted for the at least one effect. Further, the pre-built effect identifier array may be configured according to the added effect based on the identifier configuration operation, so as to acquire the effect protocol corresponding to the effect. The advantages of this setting are as follows: the configured effect protocol only affects the corresponding effect and does not affect other effects. Furthermore, the performance of accurately and quickly obtaining the effect identifiers of the corresponding effects when a plurality of effects are added to the image is realized.

S230: in response to a second effect not being added to the image to be processed, displaying the first effect in a first interaction mode.

S240: in response to the second effect being added to the image to be processed, displaying the first effect in a second interaction mode that is different from the first interaction mode.

According to the technical solution of the embodiment of the present disclosure, after the first effect to be added is determined, the second effect corresponding to the first effect is determined according to the effect identifier of at least one effect added in the image to be processed, so that the performance of accurately positioning the corresponding effect based on the effect identifier added in the image is realized, and further, the performance of improving the effect processing efficiency on the basis of reducing the memory usage is realized.

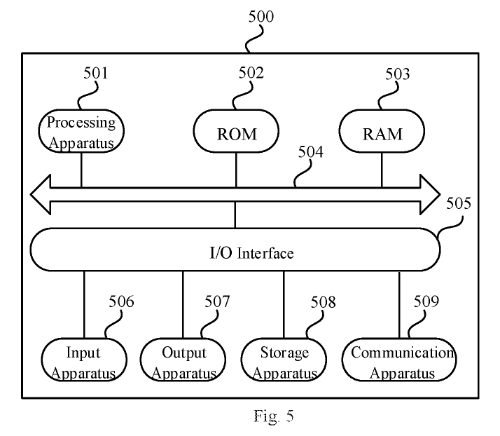

FIG. 4 is a structural schematic diagram of an effect processing apparatus provided by an embodiment of the present disclosure. As shown in FIG. 4, the apparatus includes: an effect trigger module 310, a first interaction module 320 and a second interaction module 330.

The effect trigger module 310 is configured to, in response to an effect trigger operation acting on a target display region, determine a first effect to be added and acquire an image to be processed in the target display region; the first interaction module 320 is configured to, in response to a second effect not being added to the image to be processed, display the first effect in a first interaction mode, where the first effect and the second effect have a same preset interaction object; and the second interaction module 330 is configured to, in response to the second effect being added to the image to be processed display the first effect in a second interaction mode that is different from the first interaction mode.

On the basis of the above optional technical solutions, optionally, the apparatus further includes: an effect determination module. The effect determination module is configured to determine the second effect corresponding to the first effect according to the effect identifier of at least one effect added in the image to be processed after the first effect to be added is determined.

On the basis of the above optional technical solutions, optionally, the target display region includes a plurality of layers; a layer memory object is disposed in each of the layers, and the layer memory object is at least configured to store the effect identifier of at least one effect added in the layer; and the effect determination module is specifically configured to determine a target layer on which the first effect acts from the plurality of layers included in the target display region, and determine the second effect corresponding to the first effect according to the effect identifier stored in the layer memory object corresponding to the target layer.

On the basis of the above optional technical solutions, optionally, the effect determination module includes: an identifier writing unit and an effect determination unit. The identifier writing unit is configured to write the effect identifier stored in the layer memory object corresponding to the target layer into a shared memory object corresponding to the layer; and the effect determination unit is configured to determine the second effect corresponding to the first effect according to the effect identifier in the shared memory object.

On the basis of the above optional technical solutions, optionally, the apparatus further includes: an effect protocol obtaining module. The effect protocol obtaining module is configured to acquire an effect protocol of at least one effect added in the image to be processed and determine an effect identifier of the effect according to the effect protocol, before determining the second effect corresponding to the first effect according to an effect identifier of at least one effect added in the image to be processed.

On the basis of the above optional technical solutions, optionally, the apparatus further includes: an array configuration module. The array configuration module is configured to configure, before acquiring an effect protocol of at least one effect added in the image to be processed, a pre-built effect identifier array based on an identifier configuration operation in response to the identifier configuration operation inputted for at least one effect, to obtain the effect protocol corresponding to the effect, where the effect protocol includes the effect identifier of the effect.

On the basis of the above optional technical solutions, optionally, the effect trigger module includes: an image acquisition unit. The image acquisition unit is configured to determine a target layer on which the first effect acts from a plurality of layers in response to the target display region including the plurality of layers and acquire the image to be processed according to the target layer.

On the basis of the above optional technical solutions, optionally, the first interaction mode includes a mode of displaying the first effect in association with the preset interaction object according to a preset interaction logic; and the second interaction mode at least includes a mode of displaying the first effect in a preset region of the image to be processed according to a preset display logic.

On the basis of the above optional technical solutions, optionally, the image to be processed includes a video frame in a live streaming audio-video stream; the first effect is an effect added by an audience side of the live streaming audio-video stream; and the second effect is an effect added by a live streaming side of the live streaming audio-video stream.

In the technical solution of the embodiment of the present disclosure, by determining the first effect to be added and acquiring the image to be processed in the target display region in response to the effect trigger operation acting on the target display region by the effect trigger module 310, key information required for effect processing can be automatically, accurately and quickly acquired after the effect is triggered. Further, by displaying the first effect in the first interaction mode by the first interaction module 320 when the second effect is not added to the image to be processed, because the first effect and the second effect have the same preset interaction object, in order to ensure the display performance of the first effect, the effect performance of interaction between the first effect and the interaction object can be presented in the first interaction mode; and when the second effect is added to the image to be processed, in order to ensure that the first effect does not affect the display performance of the second effect and can ensure its own display performance, the first effect is displayed in the second interaction mode different from the first interaction mode by the second interaction module 330. Accordingly, the problem that the performance of the effect added later in the related art cannot present an expected performance or even affect an original image performance is solved, an performance that the effect interaction mode of the first effect is determined separately, according to whether the corresponding second effect is added to the image to be processed that is acquired when the first effect is triggered, is realized, and the first effect can be displayed differently in different scenarios, thus enriching a performance presentation mode of the first effect and improving the overall effect display performance of the effect performance image.

The effect processing apparatus provided by the embodiment of the present disclosure can execute the effect processing method provided by any embodiment of the present disclosure, and has corresponding functional modules for executing the method and beneficial effects.

It is worth noting that the various units and modules included in the above apparatus are only divided according to functional logics, but not limited thereto, as long as the corresponding functions can be implemented; in addition, the specific names of the functional units are only for the convenience of distinguishing between each other, and are not used to limit the protection scope of the embodiments of the present disclosure.

FIG. 5 is a structural schematic diagram of an electronic device provided by an embodiment of the present disclosure. Referring to FIG. 5, FIG. 5 illustrates a structural schematic diagram of an electronic device (e.g. a terminal device or a server in FIG. 5) 500 suitable for implementing some embodiments of the present disclosure. The terminal device in some embodiments of the present disclosure may include but are not limited to a mobile terminal such as a mobile phone, a notebook computer, a digital broadcasting receiver, a personal digital assistant (PDA), a portable Android device (PAD), a portable media player (PMP), a vehicle-mounted terminal (e.g., a vehicle-mounted navigation terminal) or the like, and fixed terminals such as a digital TV, a desktop computer, or the like. The electronic device illustrated in FIG. 5 is merely an example, and should not pose any limitation to the functions and the range of use of the embodiments of the present disclosure.

The electronic device includes at least one memory and at least one processor, where the processor here may be referred to as a processing apparatus 501 described below, and the memory may include at least one selected from a group consisting of a read-only memory (ROM) 502, a random-access memory (RAM) 503, and a storage apparatus 508 hereinafter. The memory is configured to store programs for executing the methods described in the above method embodiments, and the processor is configured to execute the programs stored in the memory. The processor may include a central processing unit (CPU) or other form of processing unit having data processing capabilities and/or instruction executing capabilities, and can control other components in the electronic device to perform desired functions.

As illustrated in FIG. 5, the electronic device 500 may include a processing apparatus 501 (e.g., a central processing unit, a graphics processing unit, etc.), which can perform various suitable actions and processing according to a program stored in a read-only memory (ROM) 502 or a program loaded from a storage apparatus 508 into a random-access memory (RAM) 503. The RAM 503 further stores various programs and data required for operations of the electronic device 500. The processing apparatus 501, the ROM 502, and the RAM 503 are interconnected by means of a bus 504. An input/output (I/O) interface 505 is also connected to the bus 504.

Usually, the following apparatus may be connected to the I/O interface 505: an input apparatus 506 including, for example, a touch screen, a touch pad, a keyboard, a mouse, a camera, a microphone, an accelerometer, a gyroscope, or the like; an output apparatus 507 including, for example, a liquid crystal display (LCD), a loudspeaker, a vibrator, or the like; a storage apparatus 508 including, for example, a magnetic tape, a hard disk, or the like; and a communication apparatus 509. The communication apparatus 509 may allow the electronic device 500 to be in wireless or wired communication with other devices to exchange data. While FIG. 5 illustrates the electronic device 500 having various apparatuses, it should be understood that not all of the illustrated apparatuses are necessarily implemented or included. More or fewer apparatuses may be implemented or included alternatively.

Particularly, according to some embodiments of the present disclosure, the processes described above with reference to the flowcharts may be implemented as a computer software program. For example, some embodiments of the present disclosure include a computer program product, which includes a computer program carried by a non-transitory computer-readable medium. The computer program includes program codes for performing the methods shown in the flowcharts. In such embodiments, the computer program may be downloaded online through the communication apparatus 509 and installed, or may be installed from the storage apparatus 508, or may be installed from the ROM 502. When the computer program is executed by the processing apparatus 501, the above-mentioned functions defined in the methods of some embodiments of the present disclosure are performed.

The names of the messages or information interacted with between the plurality of apparatuses of the embodiments of the present disclosure are used for illustrative purposes only and are not intended to place limitations on the scope of those messages or information.

The electronic device provided in the embodiments of the present disclosure belongs to the same inventive concept as the effect processing method provided in the above-described embodiments, and technical details not exhaustively described in the embodiments of the present disclosure can be found in the above-described embodiments, and the present embodiments have the same beneficial effect as the above-described embodiments.

Embodiments of the present disclosure provide a non-transitory computer-readable storage medium on which computer programs is stored, the programs upon being executed by a processor realize the effect processing method provided by the above embodiments.

It should be noted that the above-mentioned computer-readable medium in the present disclosure may be a computer-readable signal medium or a computer-readable storage medium or any combination thereof. For example, the computer-readable storage medium may be, but not limited to, an electric, magnetic, optical, electromagnetic, infrared, or semiconductor system, apparatus or device, or any combination thereof. More specific examples of the computer-readable storage medium may include but not be limited to: an electrical connection with one or more wires, a portable computer disk, a hard disk, a random-access memory (RAM), a read-only memory (ROM), an erasable programmable read-only memory (EPROM or flash memory), an optical fiber, a compact disk read-only memory (CD-ROM), an optical storage device, a magnetic storage device, or any appropriate combination of them. In the present disclosure, the computer-readable storage medium may be any tangible medium containing or storing a program that can be used by or in combination with an instruction execution system, apparatus or device. In the present disclosure, the computer-readable signal medium may include a data signal that propagates in a baseband or as a part of a carrier and carries computer-readable program codes. The data signal propagating in such a manner may take a plurality of forms, including but not limited to an electromagnetic signal, an optical signal, or any appropriate combination thereof. The computer- readable signal medium may also be any other computer-readable medium than the computer- readable storage medium. The computer-readable signal medium may send, propagate or transmit a program used by or in combination with an instruction execution system, apparatus or device. The program code contained on the computer-readable medium may be transmitted by using any suitable medium, including but not limited to an electric wire, a fiber-optic cable, radio frequency (RF) and the like, or any appropriate combination of them.

In some implementation modes, the client and the server may communicate with any network protocol currently known or to be researched and developed in the future such as hypertext transfer protocol (HTTP), and may communicate (via a communication network) and interconnect with digital data in any form or medium. Examples of communication networks include a local area network (LAN), a wide area network (WAN), the Internet, and an end-to-end network (e.g., an ad hoc end-to-end network), as well as any network currently known or to be researched and developed in the future.

The above-mentioned computer-readable medium may be included in the above- mentioned electronic device, or may also exist alone without being assembled into the electronic device.

The above-mentioned computer-readable medium carries one or more programs, and when the one or more programs are executed by the electronic device, the electronic device is caused to: in response to an effect trigger operation acting on a target display region, determine a first effect to be added and acquire an image to be processed in the target display region; in response to a second effect not being added to the image to be processed, display the first effect in a first interaction mode, where the first effect and the second effect have a same preset interaction object; and in response to the second effect being added to the image to be processed, display the first effect in a second interaction mode that is different from the first interaction mode.

The computer program codes for performing the operations of the present disclosure may be written in one or more programming languages or a combination thereof. The above- mentioned programming languages include but are not limited to object-oriented programming languages such as Java, Smalltalk, C++, and also include conventional procedural programming languages such as the "C" programming language or similar programming languages. The program code may be executed entirely on the user's computer, partly on the user's computer, as a stand- alone software package, partly on the user's computer and partly on a remote computer, or entirely on the remote computer or server. In the scenario related to the remote computer, the remote computer may be connected to the user's computer through any type of network, including a local area network (LAN) or a wide area network (WAN), or the connection may be made to an external computer (for example, through the Internet using an Internet service provider).

The flowcharts and block diagrams in the accompanying drawings illustrate the architecture, functionality, and operation of possible implementations of systems, methods, and computer program products according to various embodiments of the present disclosure. In this regard, each block in the flowcharts or block diagrams may represent a module, a program segment, or a portion of codes, including one or more executable instructions for implementing specified logical functions. It should also be noted that, in some alternative implementations, the functions noted in the blocks may also occur out of the order noted in the accompanying drawings. For example, two blocks shown in succession may, in fact, can be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The units involved in the embodiments of the present disclosure may be implemented in software or hardware. The name of the unit does not constitute a limitation of the unit itself under certain circumstances.

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, the machine-readable medium may be a tangible medium that may include or store a program for use by or in combination with an instruction execution system, apparatus or device. The machine-readable medium may be a machine-readable signal medium or a machine-readable storage medium. The machine-readable medium includes, but is not limited to, an electrical, magnetic, optical, electromagnetic, infrared, or semi-conductive system, apparatus or device, or any suitable combination of the foregoing. More specific examples of machine-readable storage medium include electrical connection with one or more wires, portable computer disk, hard disk, random-access memory (RAM), read-only memory (ROM), erasable programmable read-only memory (EPROM or flash memory), optical fiber, portable compact disk read-only memory (CD-ROM), optical storage device, magnetic storage device, or any suitable combination of the foregoing.

According to one or more embodiments of the present disclosure, [Example 1]provides an effect processing method, which includes: in response to an effect trigger operation acting on a target display region, determining a first effect to be added and acquiring an image to be processed in the target display region; in response to a second effect not being added to the image to be processed, displaying the first effect in a first interaction mode, where the first effect and the second effect have a same preset interaction object; and in response to the second effect being added to the image to be processed, displaying the first effect in a second interaction mode that is different from the first interaction mode.

According to one or more embodiments of the present disclosure, [Example 2] provides the method of example 1, which further includes:

Optionally, after determining a first effect to be added, the effect processing method further includes: determining the second effect corresponding to the first effect according to an effect identifier of at least one effect added in the image to be processed.

According to one or more embodiments of the present disclosure, [Example 3] provides the method of example 2, which further includes:

Optionally, the target display region includes a plurality of layers; a layer memory object is disposed in each of the plurality of layers, and the layer memory object is at least configured to store an effect identifier of at least one effect added in the layer; and the determining the second effect corresponding to the first effect according to an effect identifier of at least one effect added in the image to be processed includes: determining a target layer on which the first effect acts from the plurality of layers included in the target display region, and determining the second effect corresponding to the first effect according to the effect identifier stored in the layer memory object corresponding to the target layer.

According to one or more embodiments of the present disclosure, [Example 4] provides the method of example 3, which further includes:

Optionally, the determining the second effect corresponding to the first effect according to the effect identifier stored in the layer memory object corresponding to the target layer includes: writing the effect identifier stored in the layer memory object corresponding to the target layer into a shared memory object corresponding to the layer; and determining the second effect corresponding to the first effect according to the effect identifier in the shared memory object.

According to one or more embodiments of the present disclosure, [Example 5] provides the method of example 2, which further includes:

Optionally, before the determining the second effect corresponding to the first effect according to an effect identifier of at least one effect added in the image to be processed, the effect processing method further includes: acquiring an effect protocol of at least one effect added in the image to be processed and determining the effect identifier of the effect according to the effect protocol.

According to one or more embodiments of the present disclosure, [Example 6] provides the method of example 2, which further includes:

Optionally, before the acquiring an effect protocol of the at least one effect added in the image to be processed, the effect processing method further includes: in response to an identifier configuration operation inputted for at least one effect, configuring a pre-built effect identifier array based on the identifier configuration operation, to obtain the effect protocol corresponding to the effect, where the effect protocol includes the effect identifier of the effect.

According to one or more embodiments of the present disclosure, [Example 7] provides the method of example 1, which further includes:

Optionally, the acquiring an image to be processed in the target display region includes: in response to the target display region including a plurality of layers, determining a target layer on which the first effect acts from the plurality of layers and acquiring the image to be processed according to the target layer.

According to one or more embodiments of the present disclosure, [Example 8] provides the method of example 1, which further includes:

Optionally, the first interaction mode includes a mode of displaying the first effect in association with the preset interaction object according to a preset interaction logic; and the second interaction mode at least includes a mode of displaying the first effect in a preset region of the image to be processed according to a preset display logic.

According to one or more embodiments of the present disclosure, [Example 9] provides the method of example 1, which further includes:

Optionally, the image to be processed includes a video frame in a live streaming audio- video stream; the first effect is an effect added by an audience side of the live streaming audio- video stream; and the second effect is an effect added by a live streaming side of the live streaming audio-video stream.

According to one or more embodiments of the present disclosure, [Example 10] provides an effect processing apparatus, which includes:

an effect trigger module configured to, in response to an effect trigger operation acting on a target display region, determine a first effect to be added and acquire an image to be processed in the target display region; a first interaction module configured to, in response to a second effect not being added to the image to be processed, display the first effect in a first interaction mode, where the first effect and the second effect have a same preset interaction object; and a second interaction module configured to, in response to the second effect being added to the image to be processed, display the first effect in a second interaction mode that is different from the first interaction mode.

The foregoing are merely descriptions of the preferred embodiments of the present disclosure and the explanations of the technical principles involved. It will be appreciated by those skilled in the art that the scope of the disclosure involved herein is not limited to the technical solutions formed by a specific combination of the technical features described above, and shall cover other technical solutions formed by any combination of the technical features described above or equivalent features thereof without departing from the concept of the present disclosure. For example, the technical features described above may be mutually replaced with the technical features having similar functions disclosed herein (but not limited thereto) to form new technical solutions.

In addition, while operations have been described in a particular order, it shall not be construed as requiring that such operations are performed in the stated specific order or sequence. Under certain circumstances, multitasking and parallel processing may be advantageous. Similarly, while some specific implementation details are included in the above discussions, these shall not be construed as limitations to the present disclosure. Some features described in the context of a separate embodiment may also be combined in a single embodiment. Rather, various features described in the context of a single embodiment may also be implemented separately or in any appropriate sub-combination in a plurality of embodiments.

Although the present subject matter has been described in a language specific to structural features and/or logical method acts, it will be appreciated that the subject matter defined in the appended claims is not necessarily limited to the particular features and acts described above. Rather, the particular features and acts described above are merely exemplary forms for implementing the claims.

1. An effect processing method, comprising:
in response to an effect trigger operation acting on a target display region, determining a first effect to be added and acquiring an image in the target display region;
in response to a second effect not being added to the image, displaying the first effect in a first interaction mode, wherein the first effect and the second effect have a same preset interaction object; and
in response to the second effect being added to the image, displaying the first effect in a second interaction mode that is different from the first interaction mode.

2. The effect processing method according to claim 1, wherein after the determining a first effect to be added, the effect processing method further comprises:
determining the second effect corresponding to the first effect according to an effect identifier of at least one effect added in the image.

3. The effect processing method according to claim 2, wherein the target display region comprises a plurality of layers; a layer memory object is disposed in each of the plurality of layers, and the layer memory object is at least configured to store an effect identifier of at least one effect added in the layer; and
the determining the second effect corresponding to the first effect according to an effect identifier of at least one effect added in the image comprises:
determining a target layer on which the first effect acts from the plurality of layers comprised in the target display region, and determining the second effect corresponding to the first effect according to the effect identifier stored in the layer memory object corresponding to the target layer.

4. The effect processing method according to claim 3, wherein the determining the second effect corresponding to the first effect according to the effect identifier stored in the layer memory object corresponding to the target layer comprises:
writing the effect identifier stored in the layer memory object corresponding to the target layer into a shared memory object corresponding to the layer; and
determining the second effect corresponding to the first effect according to the effect identifier in the shared memory object.

5. The effect processing method according to claim 2, wherein before the determining the second effect corresponding to the first effect according to an effect identifier of at least one effect added in the image, the effect processing method further comprises:
acquiring effect protocol of at least one effect added in the image and determining the effect identifier of the effect according to the effect protocol.

6. The effect processing method according to claim 5, wherein before the acquiring an effect protocol of the at least one effect added in the image, the effect processing method further comprises:
in response to an identifier configuration operation inputted for at least one effect, configuring a pre-built effect identifier array based on the identifier configuration operation, to obtain the effect protocol corresponding to the effect, wherein the effect protocol comprises the effect identifier of the effect.

7. The effect processing method according to claim 1, wherein the acquiring an image in the target display region comprises:
in response to the target display region comprising a plurality of layers, determining a target layer on which the first effect acts from the plurality of layers and acquiring the image according to the target layer.

8. The effect processing method according to claim 1, wherein the first interaction mode comprises a mode of displaying the first effect in association with the preset interaction object according to a preset interaction logic; and the second interaction mode at least comprises a mode of displaying the first effect in a preset region of the image according to a preset display logic.

9. The effect processing method according to claim 1, wherein the image comprises a video frame in a live streaming audio-video stream; the first effect is an effect added by an audience side of the live streaming audio-video stream; and the second effect is an effect added by a live streaming side of the live streaming audio-video stream.

10. An electronic device, comprising:
at least one processor; and
at least one memory, configured to store at least one program,
wherein, the at least one program, upon being executed by the at least one processor, causes the at least one processor to implement an effect processing method, and the effect processing method comprises:
in response to an effect trigger operation acting on a target display region, determining a first effect to be added and acquiring an image in the target display region;
in response to a second effect not being added to the image, displaying the first effect in a first interaction mode, wherein the first effect and the second effect have a same preset interaction object; and
in response to the second effect being added to the image, displaying the first effect in a second interaction mode that is different from the first interaction mode.

11. The electronic device according to claim 10, wherein after the determining a first effect to be added, the effect processing method further comprises:
determining the second effect corresponding to the first effect according to an effect identifier of at least one effect added in the image.

12. The electronic device according to claim 11, wherein the target display region comprises a plurality of layers; a layer memory object is disposed in each of the plurality of layers, and the layer memory object is at least configured to store an effect identifier of at least one effect added in the layer; and
the determining the second effect corresponding to the first effect according to an effect identifier of at least one effect added in the image comprises:
determining a target layer on which the first effect acts from the plurality of layers comprised in the target display region and determining the second effect corresponding to the first effect according to the effect identifier stored in the layer memory object corresponding to the target layer.

13. The electronic device according to claim 12, wherein the determining the second effect corresponding to the first effect according to the effect identifier stored in the layer memory object corresponding to the target layer comprises:
writing the effect identifier stored in the layer memory object corresponding to the target layer into a shared memory object corresponding to the layer; and
determining the second effect corresponding to the first effect according to the effect identifier in the shared memory object.

14. The electronic device according to claim 11, wherein before the determining the second effect corresponding to the first effect according to an effect identifier of at least one effect added in the image, the effect processing method further comprises:
acquiring an effect protocol of at least one effect added in the image and determining the effect identifier of the effect according to the effect protocol.

15. The electronic device according to claim 14, wherein before the acquiring an effect protocol of the at least one effect added in the image, the effect processing method further comprises:
in response to an identifier configuration operation inputted for at least one effect, configuring a pre-built effect identifier array based on the identifier configuration operation, to obtain the effect protocol corresponding to the effect, wherein the effect protocol comprises the effect identifier of the effect.

16. The electronic device according to claim 10, wherein the acquiring an image in the target display region comprises:
in response to the target display region comprising a plurality of layers, determining a target layer on which the first effect acts from the plurality of layers and acquiring the image according to the target layer.

17. The electronic device according to claim 10, wherein the first interaction mode comprises a mode of displaying the first effect in association with the preset interaction object according to a preset interaction logic; and the second interaction mode at least comprises a mode of displaying the first effect in a preset region of the image according to a preset display logic.

18. The electronic device according to claim 10, wherein the image comprises a video frame in a live streaming audio-video stream; the first effect is an effect added by an audience side of the live streaming audio-video stream; and the second effect is an effect added by a live streaming side of the live streaming audio-video stream.

19. A non-transitory computer-readable storage medium, comprising computer-executable instructions, wherein the computer-executable instructions, upon being executed by a processor, execute an effect processing method, and the effect processing method comprises:
in response to an effect trigger operation acting on a target display region, determining a first effect to be added and acquiring an image in the target display region;
in response to a second effect not being added to the image, displaying the first effect in a first interaction mode, wherein the first effect and the second effect have a same preset interaction object; and
in response to the second effect being added to the image, displaying the first effect in a second interaction mode that is different from the first interaction mode.

20. The storage medium according to claim 19, wherein after the determining a first effect to be added, the effect processing method further comprises:
determining the second effect corresponding to the first effect according to an effect identifier of at least one effect added in the image.
